(19) United States
(12) Patent Application Publication
(10) Pub. No.: US 2024/0061750 A1
(43) Pub. Date: Feb. 22, 2024

(54) BACKUP STATUS NOTIFIER FOR CLOSED COMPUTER NETWORKS

(71) Applicant: Alcon Inc., Fribourg (CH)

(72) Inventor: Marec Weber, Erlangen (DE)

(21) Appl. No.: 18/450,723

(22) Filed: Aug. 16, 2023

Related U.S. Application Data
(60) Provisional application No. 63/371,950, filed on Aug. 19, 2022.

(51) Int. Cl. G06F 11/14

(52) U.S. Cl. CPC G06F 11/1464; G06F 2201/84

(57) ABSTRACT

A computer network comprises a computer group and an administrator computer. The computer group comprises computers, where each computer has a signaling apparatus that can indicate the status of the computer. The administrator computer, which is coupled to the computer group, utilizes a signaling apparatus software that is designed to instruct the signaling apparatus of a computer to identify the computer. The administrator computer repurposes the signaling apparatus software to perform the following for each computer of the computer group: when a backup process is running, instruct the signaling apparatus of the computer to display a backup running signal; and when the backup process has completed, instruct the signaling apparatus to display a backup completed signal.

### TECHNICAL FIELD

The present disclosure relates generally to computer networks, and more particularly to a backup status notifier for closed computer networks.

### BACKGROUND

In a computer data backup process, computer data is copied onto a backup medium. The copy of the data is stored elsewhere so that, in the event of a data loss, the copy can be used to restore the original data. In medical systems, the backup process may be performed to generate backup copies of important medical information.

### BRIEF SUMMARY

In certain embodiments, a computer network comprises a computer group and an administrator computer. The computer group comprises computers, where each computer has a signaling apparatus that can indicate the status of the computer. The administrator computer, which is coupled to the computer group, utilizes a signaling apparatus software that is designed to instruct the signaling apparatus of a computer to identify the computer. The administrator computer repurposes the signaling apparatus software to perform the following for each computer of the computer group: when a backup process is running, instruct the signaling apparatus of the computer to display a backup running signal; and when the backup process has completed, instruct the signaling apparatus to display a backup completed signal.

Embodiments may include none, one, some, or all of the following features: The administrator computer further performs the following for each computer of the computer group: when a backup medium is removed from the computer, instruct the signaling apparatus to turn off. The signaling apparatus comprises an illuminator that emits light. The illuminator may blink for the backup running signal and may continuously emit light for the backup completed signal. The signaling apparatus comprises a speaker that emits a sound. The speaker may emit the sound discontinuously for the backup running signal and may emit the sound continuously for the backup completed signal. The computer network is a closed computer network.

In certain embodiments, a method for backing up a computer network includes repurposing, by an administrator computer of the computer network, a signaling apparatus software. The computer network comprises a computer group and the administrator computer. The computer group comprises computers, where each computer has a signaling apparatus that indicates a status of the computer. The signaling apparatus software is designed to instruct the signaling apparatus of a computer to identify the computer. Here, the signaling apparatus software is repurposed to perform the following for each computer of the computer group: when a backup process is running, instruct the signaling apparatus of the computer to display a backup running signal; and when the backup process has completed, instruct the signaling apparatus to display a backup completed signal.

Embodiments may include none, one, some, or all of the following features: The method further comprises performing the following for each computer of the computer group: when a backup medium is removed from the computer, instructing the signaling apparatus to turn off. The signaling apparatus comprises an illuminator configured to emit light. The method may include blinking, by the illuminator, for the backup running signal. The method may include continuously emitting, by the illuminator, light for the backup completed signal. The signaling apparatus comprises a speaker that emits a sound. The method may include emitting, by the speaker, the sound discontinuously for the backup running signal. The method may include emitting, by the speaker, the sound continuously for the backup completed signal. The computer network is a closed computer network.

In certain embodiments, a computer network comprises a computer group and an administrator computer. The computer group comprises computers. Each computer has a signaling apparatus that can indicate the status of the computer, where the signaling apparatus comprises an illuminator that emits light. The administrator computer, which is coupled to the computer group, utilizes a signaling apparatus software that is designed to instruct the signaling apparatus of a computer to identify the computer. The administrator computer repurposes the signaling apparatus software to perform the following for each computer of the computer group: when a backup process is running, instruct the signaling apparatus of the computer to display a backup running signal, where the illuminator blinks for the backup running signal; when the backup process has completed, instruct the signaling apparatus to display a backup completed signal, where the illuminator continuously emits light for the backup completed signal; and when a backup medium is removed from the computer, instruct the signaling apparatus to turn off.

Embodiments may include none, one, some, or all of the following features: The signaling apparatus further includes a speaker that emits a sound. The speaker can emit the sound discontinuously for the backup running signal, and emit the sound continuously for the backup completed signal.

### BRIEF DESCRIPTION OF THE DRAWINGS

FIG. 1 illustrates an example of a computer network 10, according to certain embodiments; and

FIG. 2 illustrates an example of a method that may be used to communicate the backup status of the computers of the network of FIG. 1, according to certain embodiments.

### DESCRIPTION OF EXAMPLE EMBODIMENTS

Referring now to the description and drawings, example embodiments of the disclosed apparatuses, systems, and methods are shown in detail. The description and drawings are not intended to be exhaustive or otherwise limit the claims to the specific embodiments shown in the drawings and disclosed in the description. Although the drawings represent possible embodiments, the drawings are not necessarily to scale and certain features may be simplified, exaggerated, removed, or partially sectioned to better illustrate the embodiments.

Computers are often equipped with a signaling apparatus (SA) (e.g., a light-emitting diode (LED) that allows a server administrator to detect a single computer within a network of several computers similar in type and/or appearance. The signaling apparatus can be switched on remotely via software through network access and highlight the appropriate computer for easy identification.

Certain end consumers, e.g., medical companies, may use a closed network that hosts its own data and has its own backup capabilities, which may better protect confidential information. Closed networks tend to be smaller and self-contained, so the signaling apparatus is typically not needed to identify a computer. Accordingly, examples herein describe changing the purpose of the signaling apparatus from identifying a computer to indicating the backup process status of the computer. The examples use off-the-shelf (OTS) hardware as-is, so they may avoid regulatory action and additional certification.

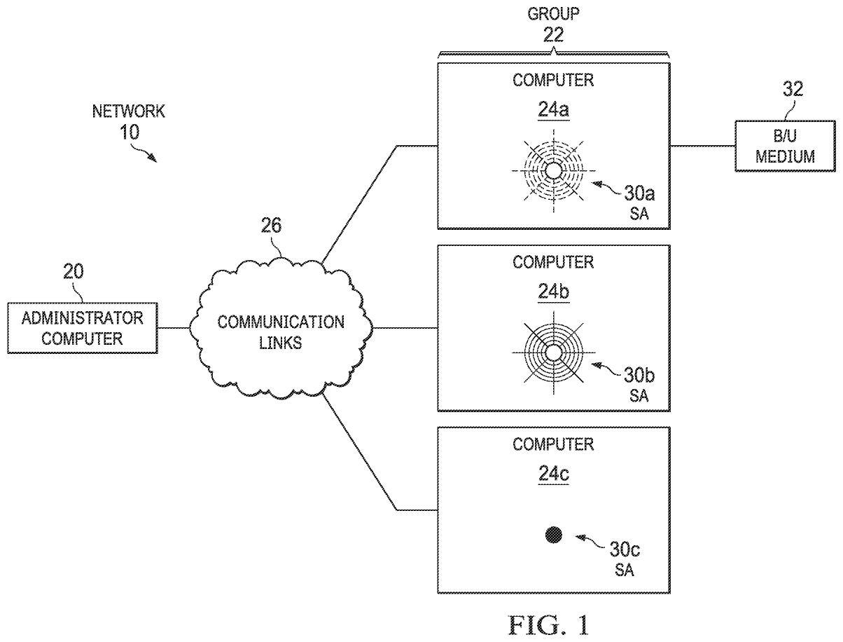

FIG. 1 illustrates an example of a computer network 10, according to certain embodiments. As an overview of the example, network 10 includes an administrator computer 20 and a group 22 of any suitable number of computers 24 (24a, 24b, 24c). Each computer 24 (24a, 24b, 24c) has a signaling apparatus 30 (30a, 30b, 30c). A backup (B/U) medium 32 stores copies of data from a computer 24. Communication links 26 communicatively couple computers 20, 24 of network 10 to allow computers 20, 24 to communicate with each other. In certain applications, computer network 10 may be used by an end consumer such as a medical company that uses the network 10 to store medical information.

As an overview of an example of operation, administrator computer 20 performs the following for each computer 24 of computer group 22: when a backup process is running, instruct signaling apparatus 30 of computer 24 to display a backup running signal; and when the backup process has completed, instruct signaling apparatus 30 of computer 24 to display a backup completed signal. Administrator computer may also instruct signaling apparatus 30 to turn off when a backup medium 32 is removed from the computer.

Turning to the components, a computer 20, 24 of network 10 may include an interface, logic, and/or memory, any of which may include computer hardware and/or software. An interface can receive input to the component and/or send output from the component, and is typically used to exchange information between, e.g., software, hardware, peripheral devices, users, and combinations of these. A user interface is a type of interface that a user can utilize to communicate with (e.g., send input to and/or receive output from) a computer. Examples of user interfaces include a display, Graphical User Interface (GUI), touchscreen, keyboard, mouse, gesture sensor, microphone, and speakers.

Logic can perform operations of a computer 20, 24. Logic may include one or more electronic devices that process data, e.g., execute instructions to generate output from input. Examples of such an electronic device include a computer, processor, microprocessor (e.g., a Central Processing Unit (CPU)), and computer chip. Logic may include computer software that encodes instructions capable of being executed by an electronic device to perform operations. Examples of computer software include a computer program, application, and operating system.

A memory (e.g., a memory of computer 20, 24 or backup medium 32) can store information and may comprise tangible, computer-readable, and/or computer-executable storage medium. Examples of memory include computer memory (e.g., Random Access Memory (RAM) or Read Only Memory (ROM)), mass storage media (e.g., a hard disk), removable storage media (e.g., a Compact Disk (CD) or Digital Video or Versatile Disk (DVD)), database, network storage (e.g., a server), and/or other computer-readable media. Particular embodiments may be directed to memory encoded with computer software.

Administrator computer 20 may perform operations to back up computers 24. During the backup process, computer 20 facilitates selection, extraction, and/or manipulation of data for storage. The process may also involve compression, encryption, and de-duplication of data. Administrator computer 20 may perform other operations to manage computers 24, such as coordinating communication among computers 24, updating computers 24, and trouble-shooting computers 24.

As described above, a computer 24 is typically equipped with a signaling apparatus (SA) that allows a server administrator to detect a single computer within a network that may include several computers similar in type and/or appearance. A computer 24 includes SA software that is typically used to switch on the signaling apparatus through network access to highlight computer 24 for easy identification.

In embodiments of the invention, administrator computer 20 repurposes the SA software to instruct the signaling apparatus to display the status of a backup process of computer 24 instead of to identify the computer 24. That is, instead of instructing the signaling apparatus to emit a signal to identify itself, administrator computer 20, in response to the start of a particular stage of the backup process, instructs the signaling apparatus to emit a signal that indicates the particular stage, i.e., the status, of the backup process.

Signaling apparatus 30 indicates a backup status of a computer 24. The backup statuses may include, e.g., backup running, backup completed, and off statuses. The backup running status indicates that backup medium 32 is connected to computer 24 and the backup process is running. To avoid data corruption or data loss resulting from improper removal of backup medium 32, removal of medium 32 is not recommended at this point. The backup completed status indicates that the backup process is completed. Backup medium 32 may be safely removed. The off status indicates backup medium 32 is not connected to computer 24.

Signaling apparatus 30 may be any suitable device that can communicate the backup status via, e.g., sight and/or sound. Examples of signaling apparatus 30 include an illuminator and a speaker. An illuminator is a light source (e.g., light bulb or LED) that emits light to communicate the status. A speaker emits a sound, e.g., a tone or a beep, to communicate the status. Signaling apparatus 30 may communicate the status in any suitable manner. In certain embodiments, the backup running status may be communicated by a continuous signal (e.g., a continuous light or sound), and the backup completed status may be communicated by a discontinuous signal (e.g., a blinking light or beeping sound), or vice-versa in different embodiments. A discontinuous signal may have any suitable frequency (e.g., 0.2 cycles per second to 1 cycle per 5 seconds).

Communication links 26 communicatively couple computers 20, 24 of network 10 to allow computers 20, 24 to communicate with each other. For example, communication links 26 couple administrator computer 20 to computers 24 of group 22. Communication links 26 include any suitable links that communicatively couple the computers of network 10. Examples of links include wired or wireless links, such as cables, cords, or a network, e.g., a Personal Area Network (PAN), Local Area Network (LAN), Wireless Local Area Network (WLAN), and Campus Area Network (CAN). While backup up computers 24, administrator computer 20 may communicate with the software of signaling apparatus 30 via a TCP/IP protocol, without requiring direct access (via, e.g., keyboard, mouse, or other input device) to the software. Backup (B/U) medium 32 stores copies of data from a computer 24.

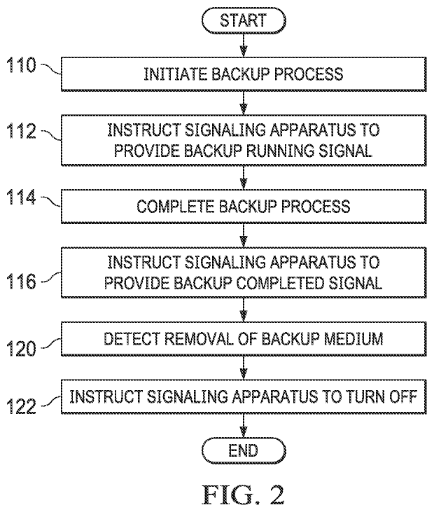

FIG. 2 illustrates an example of a method that may be used to communicate the backup status of computers of the computer network of FIG. 1, according to certain embodiments. The method starts at step 110, where administrator computer 20 initiates the backup process for a computer 24. Administrator computer 20 instructs signaling apparatus 30 to provide a backup running signal at step 112. In response, signaling apparatus 30 may emit a discontinuous light or sound, e.g., blink or beep. (See, e.g., computer 24a of FIG. 1.) Backup medium 32 is connected to computer 24, and the backup process is conducted.

The backup process is completed at step 114. Administrator computer 20 instructs signaling apparatus 30 to provide a backup completed signal at step 116. In response, signaling apparatus 30 may emit a continuous light or sound. (See, e.g., computer 24b of FIG. 1.) Backup medium 32 is disconnected from computer 24, and administrator computer 20 detects removal of backup medium 32 at step 120. In response, administrator computer 20 instructs signaling apparatus to turn off at step 122. In response, signaling apparatus 30 may cease emitting light or sound. (See, e.g., computer 24c of FIG. 1.) The method ends.

Although this disclosure has been described in terms of certain embodiments, modifications (such as changes, substitutions, additions, omissions, and/or other modifications) of the embodiments will be apparent to those skilled in the art. Accordingly, modifications may be made to the embodiments without departing from the scope of the invention. For example, modifications may be made to the systems and apparatuses disclosed herein. The components of the systems and apparatuses may be integrated or separated, or the operations of the systems and apparatuses may be performed by more, fewer, or other components, as apparent to those skilled in the art. As another example, modifications may be made to the methods disclosed herein. The methods may include more, fewer, or other steps, and the steps may be performed in any suitable order, as apparent to those skilled in the art.

To aid the Patent Office and readers in interpreting the claims, Applicants note that they do not intend any of the claims or claim elements to invoke 35 U.S.C. § 112(f), unless the words “means for” or “step for” are explicitly used in the particular claim. Use of any other term (e.g., “mechanism,” “module,” “device,” “unit,” “component,” “element,” “member,” “apparatus,” “machine,” “system,” “processor,” or “controller”) within a claim is understood by the applicants to refer to structures known to those skilled in the relevant art and is not intended to invoke 35 U.S.C. § 112(f).

What is claimed:

1. A computer network comprising:
a computer group comprising a plurality of computers, each computer having a signaling apparatus configured to indicate a status of the computer; and
an administrator computer coupled to the computer group and utilizing a signaling apparatus software designed to instruct the signaling apparatus of a computer of the computer group to identify the computer, the administrator computer configured to repurpose the signaling apparatus software to perform the following for each computer of the computer group:
when a backup process is running, instruct the signaling apparatus of the computer to display a backup running signal; and
when the backup process has completed, instruct the signaling apparatus to display a backup completed signal.

2. The computer network of claim 1, the administrator computer further configured to perform the following for each computer of the computer group:
when a backup medium is removed from the computer, instruct the signaling apparatus to turn off.

3. The computer network of claim 1, the signaling apparatus comprising an illuminator configured to emit light.

4. The computer network of claim 3, the illuminator configured to blink for the backup running signal.

5. The computer network of claim 3, the illuminator configured to continuously emit light for the backup completed signal.

6. The computer network of claim 1, the signaling apparatus comprising a speaker configured to emit a sound.

7. The computer network of claim 6, the speaker configured to emit the sound discontinuously for the backup running signal.

8. The computer network of claim 6, the speaker configured to emit the sound continuously for the backup completed signal.

9. The computer network of claim 1, the computer network being a closed computer network.

10. A method for backing up a computer network comprising:
repurposing, by an administrator computer of the computer network, a signaling apparatus software, the computer network comprising a computer group and the administrator computer, the computer group comprising a plurality of computers, each computer having a signaling apparatus configured to indicate a status of the computer, the signaling apparatus software designed to instruct the signaling apparatus of a computer of the computer group to identify the computer, the signaling apparatus software repurposed to perform the following for each computer of the computer group:
when a backup process is running, instructing the signaling apparatus of the computer to display a backup running signal; and
when the backup process has completed, instructing the signaling apparatus to display a backup completed signal.

11. The method of claim 10, further comprising performing the following for each computer of the computer group:
when a backup medium is removed from the computer, instructing the signaling apparatus to turn off.

12. The method of claim 10, the signaling apparatus comprising an illuminator configured to emit light.

13. The method of claim 12, comprising:
blinking, by the illuminator, for the backup running signal.

14. The method of claim 12, comprising:
continuously emitting, by the illuminator, light for the backup completed signal.

15. The method of claim 10, the signaling apparatus comprising a speaker configured to emit a sound.

16. The method of claim 15, comprising:
emitting, by the speaker, the sound discontinuously for the backup running signal.

17. The method of claim 15, comprising:
emitting, by the speaker, the sound continuously for the backup completed signal.

18. The computer network of claim 10, the computer network being a closed computer network.

19. A computer network comprising:
a computer group comprising a plurality of computers, each computer having a signaling apparatus configured to indicate a status of the computer, the signaling apparatus comprising an illuminator configured to emit light; and
an administrator computer coupled to the computer group and utilizing a signaling apparatus software designed to instruct the signaling apparatus of a computer of the computer group to identify the computer, the administrator computer configured to repurpose the signaling apparatus software to perform the following for each computer of the computer group:
when a backup process is running, instruct the signaling apparatus of the computer to display a backup running signal, the illuminator configured to blink for the backup running signal;
when the backup process has completed, instruct the signaling apparatus to display a backup completed signal, the illuminator configured to continuously emit light for the backup completed signal; and
when a backup medium is removed from the computer, instruct the signaling apparatus to turn off.

20. The computer network of claim 19, the signaling apparatus further comprising a speaker configured to emit a sound, the speaker configured to:
emit the sound discontinuously for the backup running signal; and
emit the sound continuously for the backup completed signal.
